(19) United States
(12) Patent Application Publication
(10) Pub. No.: US 2016/0033799 A1
(43) Pub. Date: Feb. 4, 2016

(54) COATING METHOD AND APPARATUS OF SEALANT, AND DISPLAY DEVICE

(71) Applicants: BOE TECHNOLOGY GROUP CO., TLD., Beijing (CN); BEIJING BOE OPTOELECTRONICS TECHNOLOGY CO., LTD., Beijing (CN)

(72) Inventors: Jinbo DING, Beijing (CN); Jian LI, Beijing (CN); Bin LI, Beijing (CN); Jian REN, Beijing (CN)

(73) Assignee: BEIJING BOE OPTOELECTRONICS TECHNOLOGY CO., LTD., Beijing (CN)

(21) Appl. No.: 14/429,883

(22) PCT Filed: Jun. 23, 2014
(86) PCT No.: PCT/CN2014/080530

§ 371 Date: Mar. 20, 2015

(30) Foreign Application Priority Data
Jan. 20, 2014 (CN) 201410025571.0

(51) Int. Cl. G02F 1/1339; B05C 5/02; B05D 7/00

(52) U.S. Cl. CPC G02F 1/1339; B05D 7/542; B05D 7/5423; B05C 5/0291

(57) ABSTRACT

A coating method and a coating apparatus of sealant and a display device are provided. The coating method of sealant comprises: coating an ultraviolet curable sealant around a display area on a substrate and coating an ordinary sealant on an outer side of the ultraviolet curable sealant. With the coating method, coating apparatus of sealant and the display device, by coating the sealants with different properties in different areas on the substrate, it is possible to both reduce contamination of liquid crystals by the surrounding sealant, and ensure bonding force between the sealant and the substrate, and in turn improve the display quality of the liquid crystal panel.

### TECHNICAL FIELD

Embodiments of the present invention relate to a coating method and an apparatus of sealant, and a display device.

### BACKGROUND

Liquid crystal display devices (LCDs for short) have advantages such as low weight, thin thickness, small size, low power consumption and low heat, which allow liquid crystal display devices to be applied in apparatuses such as TVs, computers, flat computers and mobile telephones widely.

Sealant for liquid crystal cell is one of critical materials in the manufacturing process of liquid crystal display devices. At present, sealant mainly contains base resin such as epoxy-acrylic resin, acrylic resin and epoxy resin, curing agent such as thermal curing agent, photoinitiator, filler such as inorganic filler and organic filler, and coupling agent. Base resin is cured mainly in two ways: ultraviolet light curing and thermal curing. Ultraviolet curing has fast speed, while thermal curing needs high temperature and long time. In order to keep good cohesiveness between sealant and substrate, coupling agent is generally added into sealant to enhance cohesiveness of sealant. At present, sealant is generally precured with ultraviolet light firstly, and then finally fully cured by heating.

At present, liquid crystal instilment is mainly implemented by one drop filling (ODF) approach, that is, liquid crystal is firstly dripped on an array substrate or a color filter substrate, then the sealant is coated on the other substrate (color filter substrate or array substrate), and subsequently substrates are assembled to form a cell.

### SUMMARY

Embodiments of the present invention provide a coating method and an apparatus of sealant and a display device to avoid contamination of liquid crystals by the sealant close to the liquid crystals due to incomplete curing in curing stage, thereby enhancing the display performance of the liquid crystal display panel.

At least one embodiment of the present invention provides a coating method of sealant, comprising: coating an ultraviolet curable sealant around a display area on a substrate and coating an ordinary sealant on an outer side of the ultraviolet curable sealant.

In one embodiment, the ultraviolet curable sealant has a width of ⅕˜½60 of an overall width of the ultraviolet curable sealant and the ordinary sealant.

In one embodiment, a mass percent of coupling agent in the ultraviolet curable sealant is 0˜2%, and a mass percent of coupling agent in the ordinary sealant is 2%˜6%.

In one embodiment, the ultraviolet curable sealant and the ordinary sealant are coated simultaneously; or the ultraviolet curable sealant on an inner side is coated firstly, and then the ordinary sealant on an outer side is coated; or the ordinary sealant on the outer side is coated firstly, and then the ultraviolet curable sealant on the inner side is coated.

Another embodiment of the present invention further provides a coating apparatus of sealant, comprising a drip nozzle, wherein the drip nozzle comprises a first part and a second part which do not communicate with each other and function to drip an ultraviolet curable sealant and an ordinary sealant respectively.

In one embodiment, the coating apparatus further comprises a cylinder configured to adjust and control the pressure applied in the first part and the second part in the drip nozzle.

In one embodiment, the coating apparatus further comprises two cylinders configured to adjust and control the pressure applied in the first part and the second part in the drip nozzle respectively.

Another embodiment of the present invention further provides a display device comprising an array substrate, an opposed substrate and liquid crystals dripped between the array substrate and the opposed substrate, wherein a sealant on the array substrate or the opposed substrate is coated by the method described above.

### BRIEF DESCRIPTION OF THE DRAWINGS

In order to explain the technical solution of embodiments of the present invention more clearly, accompanying drawings of the embodiments will be introduced briefly below. Obviously, the accompanying drawings in the following description only relate to some embodiments of the present invention rather than limiting the present invention.

FIG. 1 is a schematic diagram of a structure of a drip nozzle used in coating a sealant;

FIG. 2 is a schematic diagram of positional relation of a sealant on a substrate;

FIG. 3 is a schematic diagram of positional relation of a sealant on a substrate obtained by coating the sealant with the coating method of sealant provided in an embodiment of the present invention;

FIG. 4 is a structural representation of a drip nozzle in a coating apparatus of sealant provided in an embodiment of the present invention;

FIG. 5 is a construction diagram of a coating apparatus of sealant provided in an embodiment of the present invention;

FIG. 6 is a construction diagram of another coating apparatus of sealant provided in an embodiment of the present invention.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

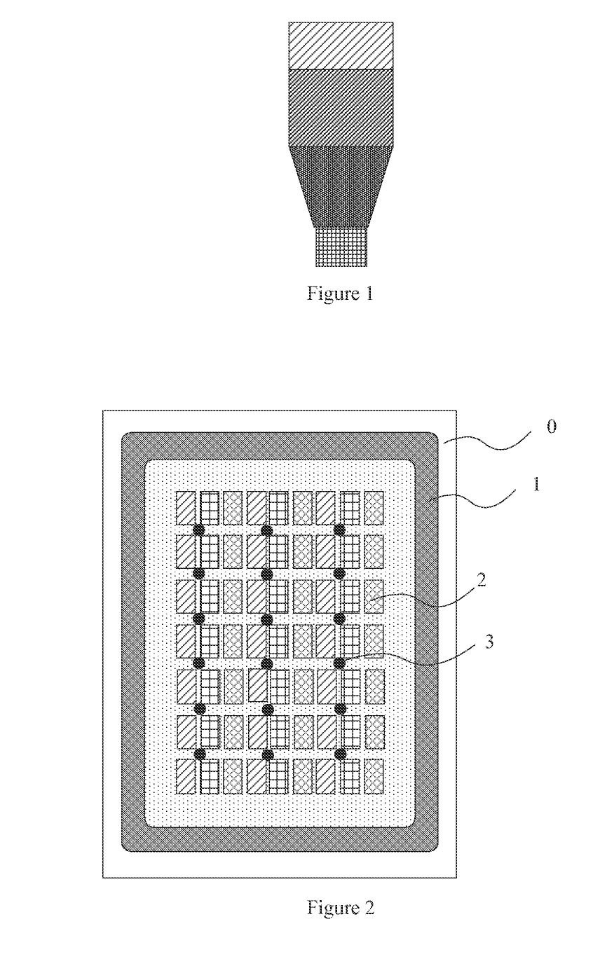

FIG. 1 is a structural representation of a drip nozzle used in coating a sealant. The drip nozzle shown in FIG. 1 is used to coat the sealant onto a substrate with a coating position relation as shown in FIG. 2. In FIG. 2, a sealant 1 is disposed on the substrate 0 such as a color filter substrate in a liquid crystal display panel, and a display area on the substrate 0 comprises pixel units 2 and spacers 3. Liquid crystals are dripped into a display area on an array substrate. After the array substrate and the color filter substrate are cell-assembled, the sealant is around the periphery of the display area filled with the liquid crystals. The sealant is precured by ultraviolet irradiation firstly after completing cell-assembling and then completely cured finally by heating. If the panel has a small size, then the liquid crystals will basically diffuse to the entire display area and contact or nearly contact the un-cured sealant after completing cell-assembling the color filter substrate and the array substrate. Though the cell-assembled panel is immediately subjected to ultraviolet irradiation for pre-curing the sealant, the pre-cured sealant is not completely cured and contains many small molecule substances such as thermal curing agent, photoinitiator, un-cured resin and coupling agent. In this case, due to the slow speed and long time of curing for the subsequent thermal curing, the liquid crystals contact the sealant that is not completely cured for a long time, allowing small molecule substances in the not-completely-cured sealant to enter the liquid crystals and contaminate the liquid crystals. Due to the contamination of the liquid crystals by the sealant, the display performance of the liquid crystal display panel, in particular the residual image performance of the liquid crystal display panel is influenced.

At least one embodiment of the present invention provides a coating method of sealant, comprising: coating an ultraviolet curable sealant around a display area on a substrate, and coating an ordinary sealant outside the ultraviolet curable sealant.

In comparison to the method of coating only one sealant, the above-mentioned coating method uses the ultraviolet curable sealant with fast curing speed on an inner side (parts near the display areas) and uses the ordinary sealant with slow curing speed but good bonding force on an outer side. This sealant coating approach can both avoid contamination of the liquid crystals by the sealant and ensure the bonding force between the substrate and the sealant, thereby enhancing the display quality of the liquid crystal panel as a whole.

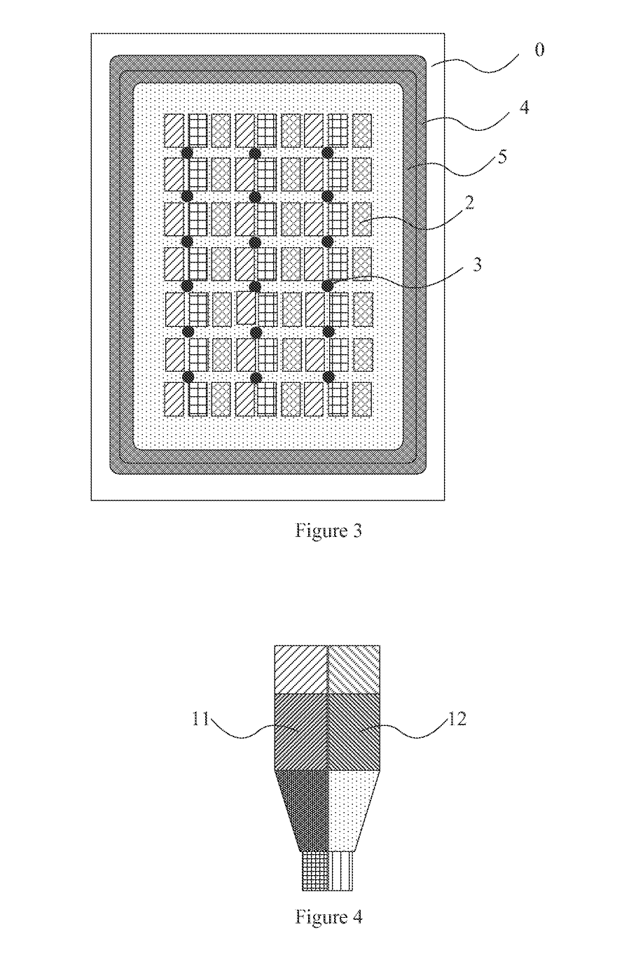

FIG. 3 is a schematic diagram of positional relation of the sealant on the substrate obtained by the above-mentioned coating method. In FIG. 3, pixel units 2 and spacers 3 are disposed in the display area on the substrate 0, an ultraviolet curable sealant 5 is disposed on an inner side close to the display area and an ordinary sealant 4 is disposed on an outer side. For example, the ordinary sealant 4 is an ordinary ultraviolet light curable and thermocurable sealant.

Since the sealant in direct contact with the liquid crystals is the ultraviolet curable sealant 5, after completing cell-assembling, the ultraviolet curable sealant 5 that contacts the liquid crystals can be cured rapidly, therefore contamination of the liquid crystals by small molecule substances such as thermal curing resin and thermal initiator in the un-cured sealant is reduced.

In order to guarantee the bonding force between the sealant and the substrate, for example, a coupling agent can be added into the sealant with a mass percent of typically 2% to 6%. In order to further reduce contamination of the liquid crystals by the coupling agent, less coupling agent can be used or no coupling agent can be used in the ultraviolet curable sealant 5. In one embodiment, for example, the mass percent of the coupling agent in the ultraviolet curable sealant 5 is from 0% to 2%.

However, substituting the ultraviolet curable sealant for the thermal curing resin such as epoxy thermal curing resin and reducing or not using the coupling agent in the ultraviolet curable sealant 5 can reduce boding force between the sealant and the substrate 1. Therefore, in order to guarantee the bonding force between the sealant and the substrate, in one embodiment, for example, the ultraviolet curable sealant 5 has a width of ⅕˜½ of the overall width of the ultraviolet curable sealant and the ordinary sealant.

In one embodiment, for example, it is possible to appropriately increase the content of epoxylite and coupling agent in the ordinary sealant 4 to guarantee the overall boding force between the sealant and the substrate. For example, the content of epoxylite in the ordinary sealant 4 is increased from 20%-25% to over 30%, and the content of coupling agent is increased from 2%-6% to over 8%.

In one embodiment, for example, the ultraviolet curable sealant 5 and the ordinary sealant 4 are coated simultaneously. Or, in one embodiment, the ultraviolet curable sealant 5 on the inner side is coated firstly, and then the ordinary sealant 4 on the outer side is coated. Or, in one embodiment, the ordinary sealant 4 on the outer side is coated firstly, and then the ultraviolet curable sealant 5 on the inner side is coated.

When the coating is effected step by step, a sealant is poured firstly into the drip nozzle and coated by ODF approach, and after completing coating this sealant, another sealant is poured into the drip nozzle and also coated by ODF approach.

With the coating method of sealant provided in at least one embodiment of the present invention, the ultraviolet curable sealant is coated near the display areas on the substrate and the ordinary sealant is coated on the outer side of the ultraviolet curable sealant. The ultraviolet curable sealant can be completely cured by ultraviolet curing with fast curing speed, thereby reducing the duration for which the sealant that is not completely cured contacts the liquid crystals, while the ordinary sealant on the outer side is completely cured by ultraviolet curing and thermal curing, thereby ensuring the bonding force between the sealant and the substrate. Therefore, it is possible to both reduce contamination of the liquid crystals in the liquid crystal panel by the surrounding sealant, avoid influence on residual image performance, and ensure the bonding force between the sealant and the substrate, and in turn improve the display quality of the liquid crystal panel.

At least one embodiment of the present invention further provides a coating apparatus for sealant, comprising a drip nozzle with a structure shown in FIG. 4. The drip nozzle includes a first part 11 and a second part 12 disposed on the left side and the right side respectively, which two parts do not communicate with each other and function to drip an ultraviolet curable sealant and an ordinary sealant respectively.

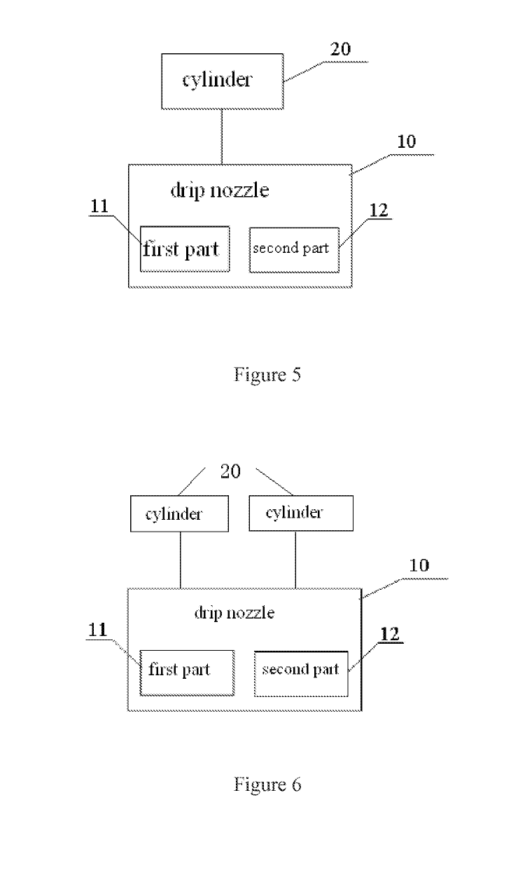

In one embodiment, for example, the coating apparatus further comprises a cylinder configured to adjust and control the pressure applied in the first part 11 and the second part 12 in the drip nozzle. The construction of the coating apparatus provided in the present embodiment is shown in FIG. 5, and the coating apparatus comprises a drip nozzle 10 and a cylinder 20. The coating pressure of the first part 11 and the second part 12 in the drip nozzle 10 are mainly controlled by the cylinder 20. By controlling the applied coating pressure, the widths of the ordinary sealant 4 and the ultraviolet curable sealant 5 are controlled.

In one embodiment, for example, the coating apparatus further comprises two cylinders configured to adjust and control the pressure applied in the first part 11 and the second part 12 in the drip nozzle respectively. The construction of the coating apparatus provided in the present embodiment is shown in FIG. 6, and the coating apparatus comprises a drip nozzle 10 and two cylinders 20. The two cylinders 20 are connected to the first part 11 and the second part 12 respectively and control the coating pressure in the first part 11 and the second part 12 respectively. By controlling the applied coating pressure, the widths of the ordinary sealant 4 and the ultraviolet curable sealant 5 are controlled.

It is to be noted that which of the two parts 11 and 12 in the drip nozzle 10 is used to drip the ordinary sealant 4 and which is used to drip the ultraviolet curable sealant 5 is set according to practical situation in use.

An embodiment of the present invention further provides a display device comprising an array substrate, an opposed substrate and liquid crystals dripped between the array substrate and the opposed substrate. A sealant on the array substrate or the opposed substrate is coated by the method described in the above-mentioned embodiments. One example of the opposed substrate is a color filter substrate.

With the coating apparatus of sealant and the display device provided in embodiments of the present invention, by coating sealants with different properties in different areas on the substrate, it is possible to both reduce contamination of the liquid crystals by the surrounding sealant, avoid influence on the residual image performance, and ensure the bonding force between the sealant and the substrate, and in turn improve the display quality of the liquid crystal panel.

The above implementations only serve to explain the present invention rather than limit the present invention. Those of ordinary skill in the art can make various modifications and variations without departing from the spirit and scope of the present invention. Therefore all equivalent technical proposals belong to the scope of the present invention and the scope of patent protection of the present invention should be defined by the claims.

The present application claims the benefits of a China patent application No. 201410025571.0 filed on Jan. 20, 2014, which is incorporated in its entirety herein by reference as part of the present application.

1. A coating method of sealant comprising: coating an ultraviolet curable sealant around a display area on a substrate and coating an ordinary sealant on an outer side of the ultraviolet curable sealant.

2. The coating method of claim 1, wherein the ultraviolet curable sealant has a width of ⅕˜½ of an overall width of the ultraviolet curable sealant and the ordinary sealant.

3. The coating method of claim 1, wherein a mass percent of a coupling agent in the ultraviolet curable sealant is 0˜2%, and a mass percent of a coupling agent in the ordinary sealant is 2%˜6%.

4. The coating method of claim 1, wherein the ultraviolet curable sealant and the ordinary sealant are coated simultaneously;
or the ultraviolet curable sealant on an inner side is coated firstly, and then the ordinary sealant on an outer side is coated;
or the ordinary sealant on the outer side is coated firstly, and then the ultraviolet curable sealant the on inner side is coated.

5. A coating apparatus of sealant comprising a drip nozzle, wherein the drip nozzle comprises a first part and a second part which do not communicate with each other and function to drip an ultraviolet curable sealant and an ordinary sealant respectively.

6. The coating apparatus of claim 5, further comprising a cylinder configured to adjust and control the pressure applied in the first part and the second part in the drip nozzle.

7. The coating apparatus of claim 5, further comprising two cylinders configured to adjust and control the pressure applied in the first part and the second part in the drip nozzle respectively.

8. A display device comprising an array substrate, an opposed substrate and liquid crystals between the array substrate and the opposed substrate, wherein sealant on the array substrate or the opposed substrate is coated by the method of claim 1.
